(19) United States
(12) Patent Application Publication
(10) Pub. No.: US 2011/0315639 A1
(43) Pub. Date: Dec. 29, 2011

(54) APPARATUS AND METHODS FOR HANDLING CATALYST SLURRIES

(75) Inventors: Joseph Debevec, Lucedale, MS (US); Matthew Parry, Semmes, AL (US)

(73) Assignee: Chevron U.S.A. Inc.

(21) Appl. No.: 12/825,159

(22) Filed: Jun. 28, 2010

(51) Int. Cl. B01D 29/00

(52) U.S. Cl. 210/773; 210/767; 210/455

(57) ABSTRACT

Apparatus and methods for handling spent catalyst, wherein a slurry comprising the catalyst may be rapidly and conveniently drained to separate a liquid from the catalyst using a separation unit including a separation vessel and having a separator plate disposed between an upper compartment and a lower compartment of the separation vessel, whereby each of the liquid and solid components of the slurry may be conveniently contained separately for subsequent treatment, transportation, and/or disposal.

### FIELD OF THE INVENTION

This invention relates to apparatus and methods for handling catalyst slurries.

### BACKGROUND OF THE INVENTION

Solid catalysts used in reactors may eventually become inactivated or spent, and the spent catalyst must be removed from the reactor for treatment or disposal in an appropriate manner. Typically, spent catalyst is removed from the reactor as an aqueous catalyst suspension or slurry. In a conventional process for the separation of liquid and solid components of a catalyst slurry, an aliquot of the total volume of slurry from the reactor is disposed in a tank. An inclined auger is dipped into the slurry and the auger rotated, whereby solid components (catalyst) slowly move up the auger to allow separation of the catalyst from the slurry. An inclined semi-circular trough may be disposed substantially co-axially with, and beneath, the auger whereby liquid from the slurry may be returned to the tank. At the same time, liquid may be slowly pumped from the tank to allow for the gradual addition of further aliquots of the slurry. This process is tedious, inefficient, expensive, and unreliable, e.g., due to the nature of the process and the susceptibility of the equipment to mechanical failure.

U.S. Pat. No. 5,589,081 to Harris discloses a liquid-solid separator tank having surrounding sides and a dividing wall. A grate overlays the sides, a screen overlays the grate, and a filter overlays the screen. The filter extends up the sides and over the dividing wall, and the filter may tear if weight is placed on it.

U.S. Pat. No. 6,364,122 to Massey discloses a liquid-solid separator tank including a dividing wall and at least one inlet in an outer wall. The dividing wall supports a filter media support structure, and the filter media extends up the dividing wall and the sides of the tank.

U.S. Pat. No. 6,619,571 to Hourticolon et al. discloses a method for emptying a tube-bundle reactor in which a suction hose, having an integral high pressure hose and high pressure nozzle, is introduced into the reactor. Catalyst within the reactor is size-reduced by injecting water from the nozzle at high pressure (50-1000 bar). The resultant catalyst/water mixture is removed from the reactor using suction. Optionally the mixture is collected in a vacuum-tight separator in a closed system.

U.S. Pat. No. 7,410,576 to Brouillard et al. discloses a mobile filtration system and method comprising a box having a filter chamber including filtering walls inclined to the box walls. The system of the '576 patent further includes an inclined filtering floor, and inclined filter panels.

There is a continuing need for improved apparatus and processes for handling spent catalyst from reactors without the use of a high pressure source for generating a catalyst slurry or a vacuum generator for suctioning the catalyst slurry from the reactor. There is a further need for the convenient and rapid drainage of large volumes of spent catalyst slurry to provide convenient containment of both drained catalyst and liquid waste.

### SUMMARY OF THE INVENTION

According to one aspect of the present invention there is provided a method for handling spent catalyst, the method comprising loading an aqueous catalyst slurry on a rigid separator plate, draining liquid from the catalyst slurry through slots in the plate to a lower compartment beneath the separator plate, and removing the liquid from the lower compartment. The separator plate may be disposed at least substantially horizontally.

In an embodiment, the present invention provides a method for handling spent catalyst, the method comprising adding water to the catalyst to form an aqueous catalyst slurry; transferring the catalyst slurry via gravity feed to an upper compartment of a separation vessel having a substantially planar separator plate disposed therein, the separator plate having a plurality of slots therein; and via the separator plate, draining liquid under gravity from the catalyst slurry through the slots to a lower compartment. The separator plate may be disposed at least substantially parallel to the base of the separation vessel, and the separator plate may define a boundary between the upper compartment and a lower compartment of the separation vessel.

In another embodiment of the present invention, there is provided apparatus comprising a separation vessel having an upper compartment and a lower compartment; and a rigid, substantially planar separator plate disposed at least substantially horizontally within the separation vessel. The separator plate defines a boundary between the upper compartment and the lower compartment, and the separator plate has a plurality of elongate slots therein. The separator plate may be disposed within the separation vessel at least substantially parallel to the base of the separation vessel.

### BRIEF DESCRIPTION OF THE DRAWINGS

FIG. 1 is a block diagram schematically representing a catalyst disposal system, according to an embodiment of the present invention;

FIG. 2 is a block diagram schematically representing a separation unit for separating liquid from a catalyst slurry, according to an embodiment of the present invention;

FIG. 3 is a block diagram schematically representing a separation vessel, according to an embodiment of the present invention;

FIG. 4 schematically represents a separation vessel, as seen in perspective view, according to an embodiment of the present invention;

FIG. 5A is a perspective view of a separation unit, and FIG. 5B is a sectional view of the separation unit of FIG. 5A as seen from the side, according to an embodiment of the present invention;

FIG. 6A is a plan view of a separation unit, and FIG. 6B is an enlarged sectional view of a lower portion of the separation unit as seen along the lines 6B-6B of FIG. 6A, according to an embodiment of the present invention;

FIG. 7A is a plan view of a separation unit, and FIG. 7B is an enlarged sectional view of a lower portion of the separation unit as seen along the lines 7B-7B of FIG. 7A, according to another embodiment of the present invention;

FIG. 8A is a perspective view of a separator plate, FIG. 8B is a plan view of the separator plate of FIG. 8A including an enlarged portion showing a plurality of slots, and FIG. 8C is an enlarged view of a slot of the separator plate, according to the present invention;

FIG. 9A is a plan view of a support unit, and FIG. 9B shows the support unit of FIG. 9A as seen along the lines 9B-9B of FIG. 9A, according to an embodiment of the present invention;

FIG. 10A schematically represents a series of steps involved in a method for handling spent catalyst, according to an embodiment of the present invention; and

FIG. 10B schematically represents a series of steps involved in a method for handling spent catalyst, according to another embodiment of the present invention.

### DETAILED DESCRIPTION OF THE INVENTION

The present invention provides apparatus and methods for handling spent catalyst from a reactor, wherein a slurry of the catalyst may be drained rapidly using separation apparatus having no moving parts, and whereby both liquid and solid components of the slurry may be easily and reliably contained.

In contrast to prior art apparatus and processes, the present invention allows handling of spent catalyst more rapidly and conveniently, at lower cost, with shorter reactor downtime, and without using machinery that is prone to mechanical failure. In one aspect, and in further contrast to the prior art, the present invention allows the removal of spent catalyst slurry from a reactor to a separation unit by gravity feed, without the use of pressurized liquid to size-reduce the catalyst. Thereafter, the liquid and catalyst components of the catalyst slurry may be separated in the separation unit by drainage under gravity at ambient pressure.

### DEFINITIONS

The following terms used herein have the meanings as defined hereinbelow, unless otherwise indicated.

The terms “drain” and “draining” refer to the removal of liquid from a liquid containing material or slurry under, or as a result of, ambient gravitational force, e.g., in the absence of suction or a vacuum generator.

The terms “gravity” and “gravitational” refer to ambient gravity or approximately Earth's gravity, 1 g.

The term “entire,” as used to describe a surface, refers to a surface that lacks voids, holes, outlet ports, or inlet ports, and the like.

Unless otherwise specified, the recitation of a genus of elements, materials, or other components from which an individual or combination of components or structures can be selected is intended to include all possible sub-generic combinations of the listed components and mixtures thereof. Also, “include” and its variants are intended to be non-limiting, such that recitation of items in a list is not to the exclusion of other like items that may also be useful in the materials, elements, structures, compositions, and methods of this invention.

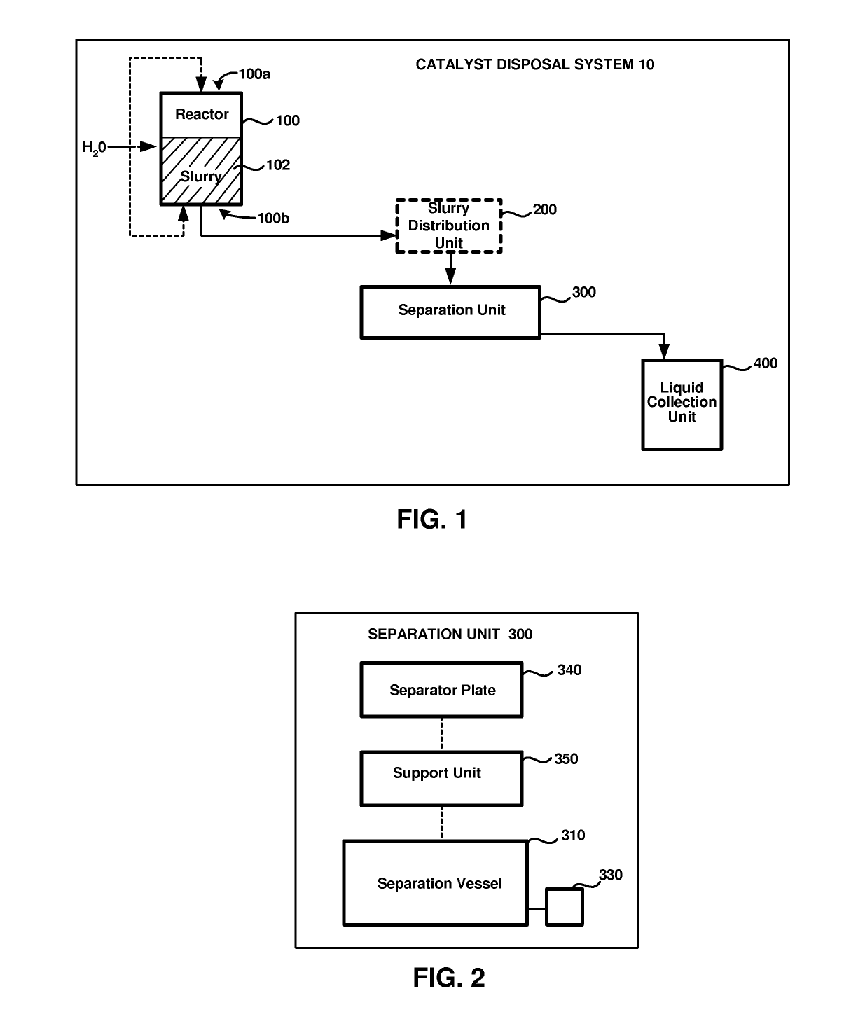

With reference to the drawings, FIG. 1 is a block diagram schematically representing a catalyst disposal system 10, according to an embodiment of the present invention. System 10 may include a reactor 100, a separation unit 300, and a liquid collection unit 400. Reactor 100 may be in fluid communication with separation unit 300. Separation unit 300 may be in fluid communication with liquid collection unit 400. System 10 may optionally further include a slurry distribution unit 200 in fluid communication with both reactor 100 and separation unit 300.

Reactor 100 may include a top portion 100a and a reactor base 100b. Reactor 100 may be configured for containing a solid catalyst, such as a catalyst for hydrocarbon processing reactions. As non-limiting examples, the catalyst may comprise a molecular sieve and/or a refractory oxide. The catalyst in reactor 100 may be at least partially inactivated or spent. Such spent catalyst may be removed from reactor 100 by the addition of water to reactor 100. Water may be added to reactor 100 at a top portion 100a, or at various locations intermediate between reactor top portion 100a and reactor base 100b. In an embodiment of the present invention, the water may be added to reactor 100 at a low pressure, e.g., in the range from about 1 bar to 20 bar.

Water added to reactor 100 may mix with the catalyst to form an aqueous catalyst suspension or slurry 102. As non-limiting examples, catalyst slurry 102 may have a volume generally in the range from about 95,000 to 125,000 liters, catalyst slurry 102 may have a solids content generally in the range from about 10 to 50 wt %, and catalyst particles in slurry 102 may typically have a size range from about 0.06 to 1.25 inch. Catalyst slurry 102 may be transferred from reactor 100 to separation unit 300 under gravity, e.g., via a hose. Typically, slurry 102 may be transferred to separation unit 300 from base 100b of reactor 100. In an embodiment of the present invention, slurry 102 may be fed or distributed to separation unit 300 via slurry distribution unit 200. Slurry distribution unit 200 may be configured for distributing slurry 102 at least substantially evenly within a separation vessel (see, e.g., FIGS. 2, 4, 5A-B) of separation unit 300. In an embodiment, slurry distribution unit 200 may comprise a slurry distribution nozzle (not shown). In a sub-embodiment, the distribution nozzle may be configured for varying the orientation of the nozzle with respect to the separation vessel.

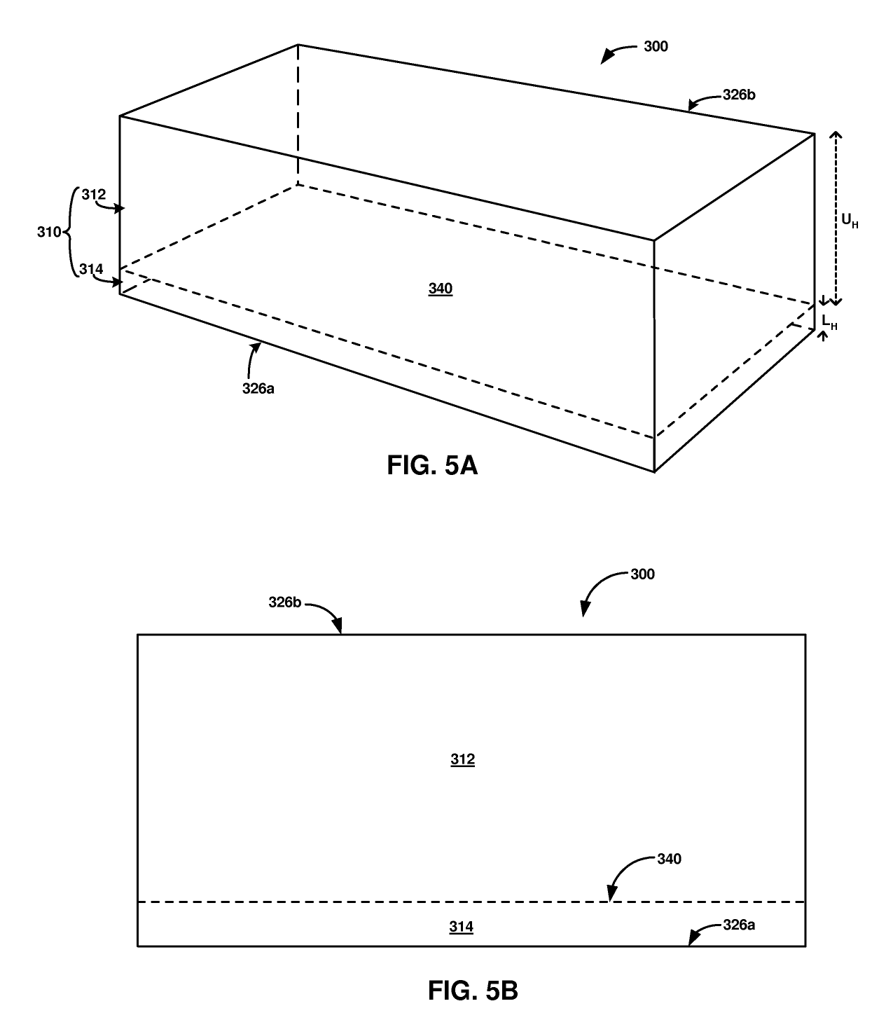

Separation unit 300 may be configured for the facile separation of liquid from catalyst particles in slurry 102. As an example, separation unit 300 may comprise apparatus substantially as described with reference to FIGS. 2 and 5A-B. The separated liquid fraction or component may be removed from separation unit 300 to liquid collection unit 400. Liquid collection unit 400 may be configured as one or more tanks, and the like. Liquid collection unit 400 may be suitable for collecting, storing, transporting, and/or treating liquid waste, such as liquid separated from slurry 102. Such liquid may comprise water that may be contaminated with materials such as heavy metals, and the like.

FIG. 2 is a block diagram schematically representing a separation unit, according to an embodiment of the present invention. Separation unit 300 may include a separation vessel 310, an outlet valve 330, a separator plate 340, and a support unit 350. Separation unit 300 may be configured for separating liquid and solid components from catalyst slurry 102. In an embodiment, separator plate 340 may be configured for rapidly draining liquid from catalyst slurry 102 under gravity when slurry 102 is disposed on plate 340. Outlet valve 330 may be configured for the removal of liquid from separation vessel 310. Separator plate 340 may be further configured for retaining slurry particles. In an embodiment, the slurry may comprise particles having a size in the range generally from about 0.06 to 1.25 inch. In an embodiment, separator plate 340 may be at least substantially planar and rigid.

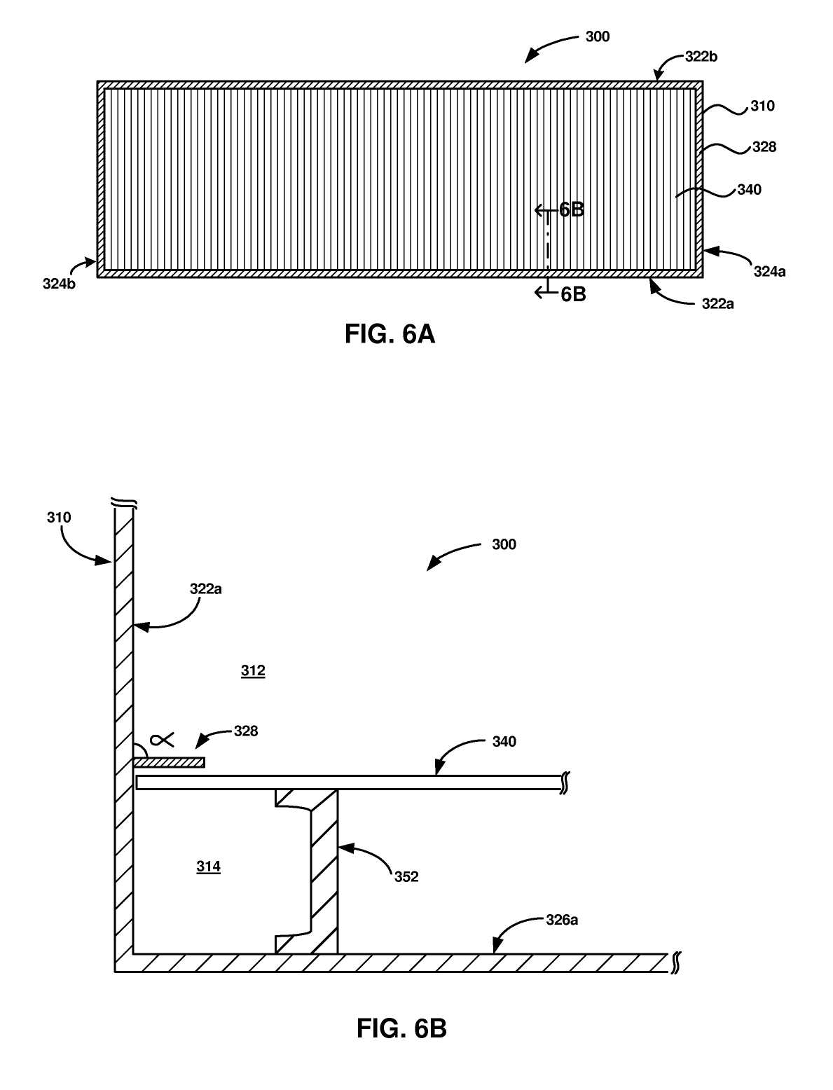

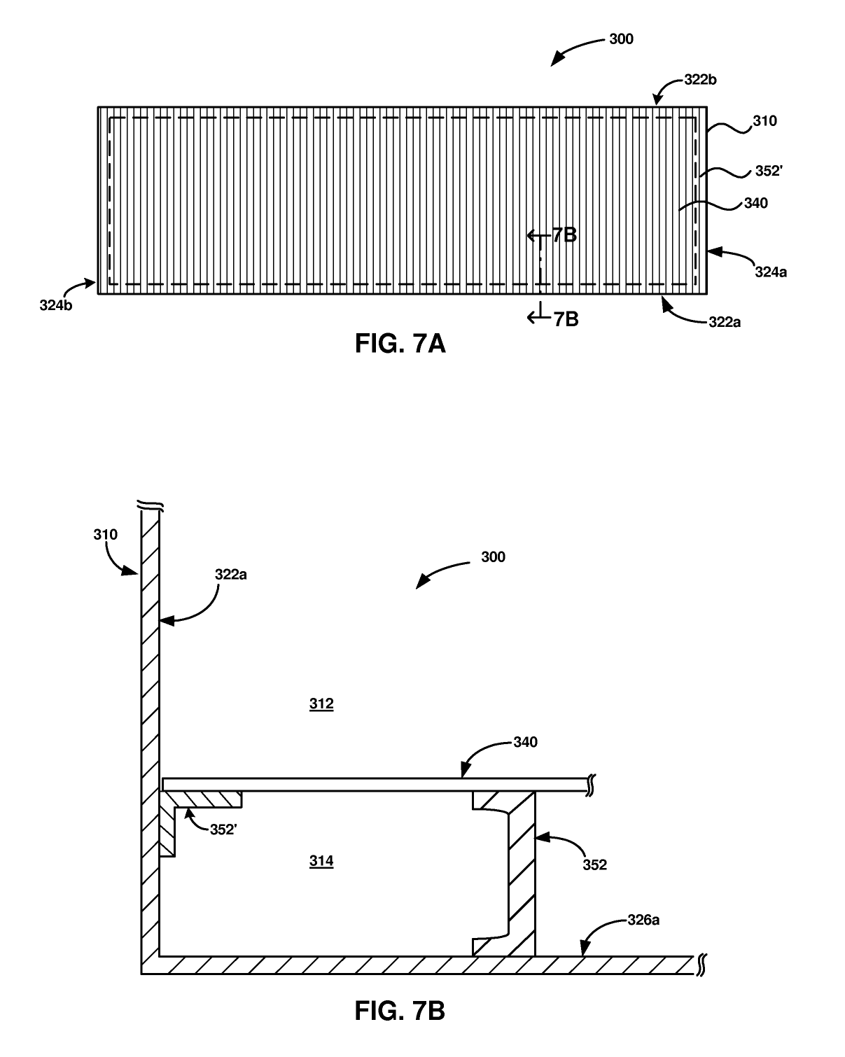

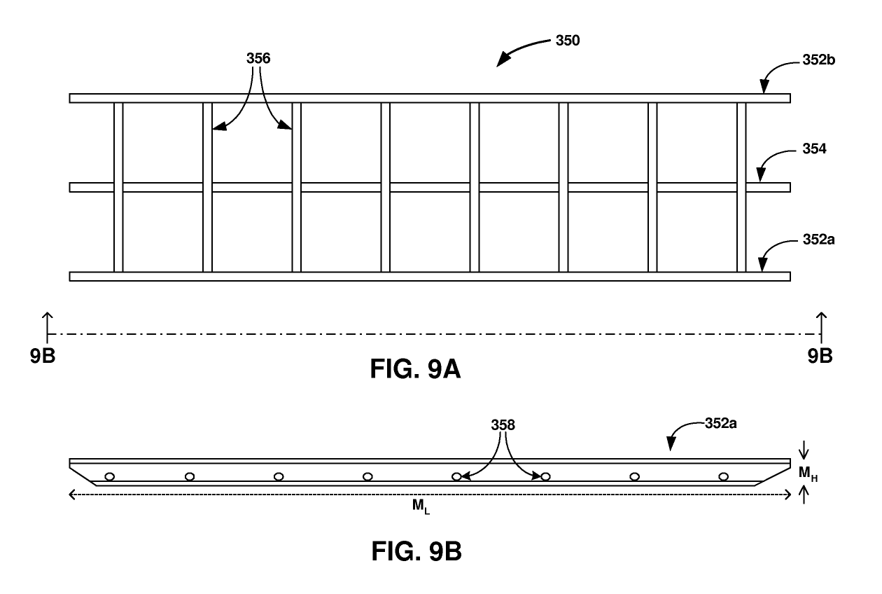

Support unit 350 may be configured for supporting plate 340 within separation vessel 310. Support unit 350 may include at least one support member (not shown in FIG. 2). The at least one support member may include at least one longitudinal support member and/or at least one transverse support member (see, e.g., FIG. 9A). In an embodiment, support unit 350 may be configured for resting at least a portion thereof on the base of separation vessel 310 (see, e.g., FIGS. 6B and 7B).

In an embodiment, plate 340 may be affixed, either permanently or temporarily, to at least a portion of support unit 350. In an embodiment, plate 340 may be affixed to support unit 350, such that plate 340 and support unit 350 form a removable vessel insert configured for facile insertion in, or removal from, separation vessel 310. In another embodiment, at least a portion of support unit 350 may be affixed, either permanently or temporarily, to separation vessel 310 (see, e.g., FIG. 7B).

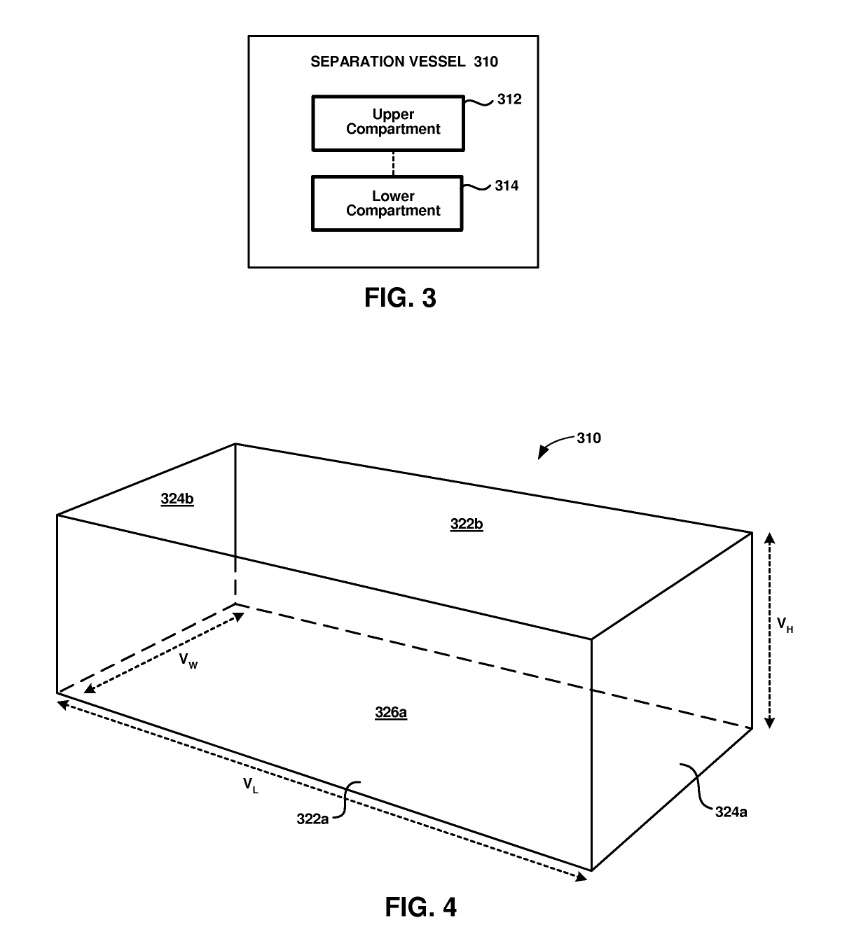

FIG. 3 is a block diagram schematically representing a separation vessel, according to an embodiment of the present invention. Separation vessel 310 may comprise an upper compartment 312 and a lower compartment 314. Separator plate 340 (not shown in FIG. 3) may be disposed between upper compartment 312 and lower compartment 314. Upper compartment 312 may be configured for receiving catalyst slurry 102 from reactor 100. Lower compartment 314 may be configured for receiving liquid that has drained from catalyst slurry 102. An outlet valve 330 (see, e.g., FIG. 2) may be provided for the removal of liquid from lower compartment 314. In an embodiment, outlet valve 330 may be disposed on a wall of lower compartment 314. In an embodiment, upper compartment 312 and lower compartment 314 may be configured substantially as shown in FIGS. 5A-B.

FIG. 4 schematically represents a separation vessel 310, as seen in perspective view, according to an embodiment of the present invention. Separation vessel 310 may be shaped substantially as a cuboid or rectangular box. Separation vessel 310 may include opposing first and second side walls 322a, 322b; opposing first and second end walls 324a, 324b; and a vessel base 326a. Separation vessel 310 may optionally further include a top or lid 326b (not shown in FIG. 4). In an embodiment, base 326a may comprise an entire interior surface, such that base 326a of vessel 310 may lack any voids, holes, outlet ports, or inlet ports, and the like. Base 326a and lid 326b of separation vessel 310 may each be rectangular.

In an embodiment, first and second side walls 322a, 322b and first and second end walls 324a, 324b may be affixed to base 326a, such that each of base 326a, first and second side walls 322a, 322b, and first and second end walls 324a, 324b may be fixed with respect to each other. In another embodiment, separation vessel 310 may include a hinged opening or door (not shown). In a sub-embodiment, one of first and second end walls 324a, 324b may comprise a hinged opening. In an embodiment, each of first and second side walls 322a, 322b, and first and second end walls 324a, 324b may be at least substantially orthogonal to base 326a. In an embodiment, first and second side walls 322a, 322b, first and second end walls 324a, 324b, and base 326a may comprise a metal, such as steel.

With further reference to FIG. 4, separation vessel 310 may have a length, V_{L}, a width, V_{W}, and a height, V_{H}. Separation vessel 310 may be of suitable size or capacity for handling an amount of solid spent catalyst, e.g., from a refinery hydroprocessing reactor. As a non-limiting example, length, V_{L} may generally be in the range from about 10 to 40 feet, more typically from about 15 to 30 feet, and often from about 20 to 25 feet. The width, V_{W} of separation vessel 310 may generally be in the range from about 4 to 12 feet, typically from about 5 to 10 feet, and often from about 6 to 9 feet. The height, V_{H} of separation vessel 310 may generally be in the range from about 3 to 12 feet, typically from about 4 to 10 feet, and often from about 4 to 8 feet. In an embodiment, separation vessel 310 may have a capacity generally in the range from about 10 to 50 cubic yards, typically from about 15 to 40 cubic yards, and often from about 15 to 30 cubic yards.

FIG. 5A is a perspective view of a separation unit 300, and FIG. 5B is a sectional view of the separation unit of FIG. 5A as seen from the side, according to an embodiment of the present invention. Separation unit 300 includes a separation vessel 310, and a separator plate 340 disposed within vessel 310. Separation vessel 310 includes an upper compartment 312 and a lower compartment 314. In an embodiment, separator plate 340 may be disposed at least substantially parallel to base 326a of vessel 310. In an embodiment, plate 340 may comprise a single layer of a stainless steel or an alloy. Plate 340 may have an area equal to or less than the area of base 326a. As a non-limiting example, plate 340 may typically have an area in the range from about 95 to 100% of the area of base 326a, and often from about 98 to 99.9% of the area of base 326a.

In an embodiment, each of upper compartment 312 and lower compartment 314 may be configured substantially as a rectangular box or cuboid. Plate 340 may define a boundary between upper compartment 312 and lower compartment 314. In an embodiment, the length and width of each of upper compartment 312 and lower compartment 314 may be substantially similar or the same as the length and width of separation vessel 310.

In an embodiment, upper compartment 312 and lower compartment 314 may be vertically aligned. Upper compartment 312 may have a height, U_{H}, and lower compartment 314 may have a height, L_{H}. In an embodiment, the height of upper compartment 312 may be greater than the height of lower compartment 314. Upper compartment height, U_{H} may be generally in the range from about 2 to 12 feet, more typically from about 3 to 10 feet, and often from about 4 to 8 feet. Lower compartment height, L_{H} may be generally in the range from about 2 to 24 inches, more typically from about 3 to 12 inches, and often from about 4 to 9 inches. Typically, the ratio of the height of the upper compartment to the height of the lower compartment, U_{H}:L_{H} may be in the range from about 2:1 to 40:1, usually from about 5:1 to 20:1, and often from about 7:1 to 15:1.

Lid 326b of separation vessel 310 may have various configurations, e.g., substantially flat, sloping, domed, and the like. Lid 326b may be moveable, and may be configured for opening or closing the top of separation vessel 310. As an example, lid 326b may be opened for loading catalyst slurry 102 within upper compartment 312. As another example, lid 326b may be closed for storage or transportation of drained spent catalyst within separation vessel 310. In an embodiment, separation vessel 310 may be equipped with rollers, wheels, or the like, to facilitate movement and transportation of separation vessel 310.

FIG. 6A is a plan view of a separation unit 300, and FIG. 6B is an enlarged sectional view of a lower portion of separation unit 300 as seen along the lines 6B-6B of FIG. 6A, according to an embodiment of the present invention. With reference to FIGS. 6A-B, separation unit 300 may include a separator plate 340 and a peripheral flap 328. Separator plate 340 may be at least substantially planar and rigid. Separator plate 340 may be disposed at least substantially parallel to base 326a of separation vessel 310. Separator plate 340 may have a length and width suitable for horizontal placement within separation vessel 310. In an embodiment, separator plate 340 may typically occupy an area at least about 95% of the area of base 326a.

In an embodiment, flap 328 may be disposed above separator plate 340. Flap 328 may be disposed adjacent to the perimeter of plate 340. Flap 328 may extend inwardly from each of first and second side walls 322a, 322b and first and second end walls 324a, 324b. Flap 328 may comprise, for example, a band or strip of a metal or plastic.

First and second side walls 322a, 322b and first and second end walls 324a, 324b may jointly define a perimeter of separation vessel 310. Separator plate 340 may be disposed within separation vessel 310 such that the perimeter of plate 340 extends substantially to the perimeter of separation vessel 310. In an embodiment, any gap or distance between the perimeter of plate 340 and the perimeter of separation vessel 310 may be in the range from about 0 to 0.20 inch, more typically from about 0 to 0.10 inch.

In an embodiment, flap 328 may be disposed adjacent to the upper surface of plate 340. Flap 328 may be configured to overlap any substantial gap(s) between the perimeter of plate 340 and the perimeter of separation vessel 310. As an example, flap 328 may be configured to prevent catalyst particles from falling beyond the perimeter of plate 340 and into lower compartment 314. Flap 328 may be disposed at an angle, α, with respect to each of walls 322a, 322b, 324a, 324b. In an embodiment, α may have a value in the range from about 75° to 120°, and more typically from about 90° to 120°.

As noted hereinabove, separator plate 340 may be supported by a support unit 350 (see, e.g., FIGS. 2 and 9A-B). In an embodiment, support unit 350 may comprise a plurality of support members 352 configured for supporting plate 340 within separation vessel 310. Only one support member 352 is shown in FIG. 6B for the sake of clarity of illustration. In practice, support member 352 may be mechanically coupled to one or more other support members, e.g., longitudinal and/or transverse support members (see, e.g., FIG. 9A). Support member 352 may be configured for resting on base 326a. In an embodiment, plate 340 may be supported within separation vessel 310 by a plurality of interconnected support members 352 resting on base 326a. In an embodiment, support member 352 may comprise a metal beam. As non-limiting examples, support member 352 may comprise a C-channel or an I-beam.

FIG. 7A is a plan view of a separation unit 300, and FIG. 7B is an enlarged sectional view of a lower portion of separation unit 300 as seen along the lines 7B-7B of FIG. 7A, according to an embodiment of the present invention. Separation unit 300 may include a separator plate 340 and a perimeter support member 352′. In an embodiment, perimeter support member 352′ may be permanently or temporarily affixed to first and second side walls 322a, 322b and/or to first and second end walls 324a, 324b. Perimeter support member 352′ may extend inwardly from the perimeter of separation vessel 310. An outer portion or perimeter of plate 340 may be disposed against perimeter support member 352′. In an embodiment, perimeter support member 352′ may comprise an angle bar or angle iron configured for at least partially supporting plate 340. Separator plate 340 may be at least substantially planar and rigid, and may be disposed at least substantially parallel to base 326a, substantially as described with reference to FIGS. 6A-B.

With reference to FIG. 7B, separation unit 300 may further comprise at least one support member 352 configured for resting on base 326a, substantially as described with reference to FIGS. 6A-B. In an embodiment, perimeter support member 352′ may serve, in conjunction with one or more of support members 352, to support plate 340 above base 326a. For example, plate 340 may be supported in part by perimeter support member 352′ and in part by one or more support members 352 resting on base 326a. Perimeter support member 352′ may also serve to prevent particulates from falling beyond the perimeter of plate 340 and into lower compartment 314. Only one support member 352 is shown in FIG. 7B for the sake of clarity of illustration. As noted hereinabove, support member 352 may be mechanically coupled to one or more other longitudinal and/or transverse support members (see, e.g., FIG. 9A). In an embodiment, support member 352 may comprise a metal beam, substantially as described with reference to FIG. 6B.

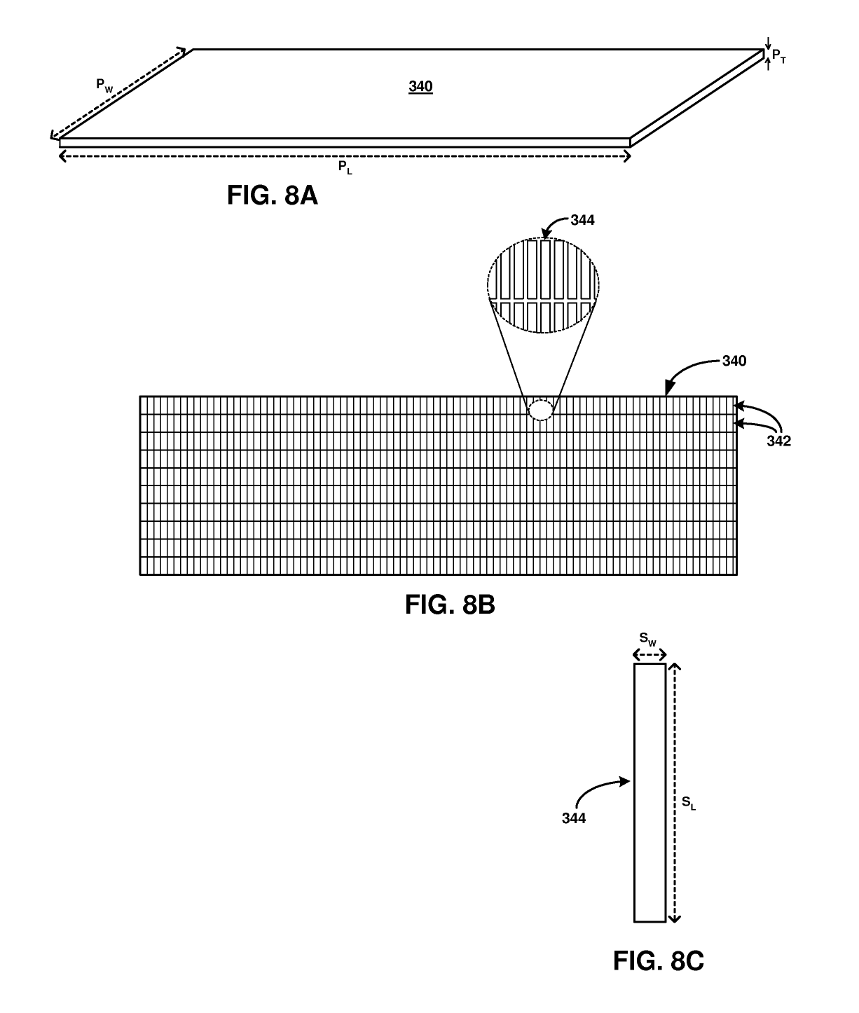

FIG. 8A is a perspective view of a separator plate, according to an embodiment of the present invention. Plate 340 may have a length, P_{L}, a width, P_{W} and a thickness, P_{T}. The plate length, P_{L} may generally be in the range from about 10 to 40 feet, typically from about 15 to 30 feet, and often from about 20 to 25 feet. The plate width, P_{W} may generally be in the range from about 4 to 12 feet, more typically from about 5 to 10 feet, and often from about 6 to 9 feet. The plate thickness, P_{T} may generally be in the range from about-0.025 to 0.5 inch, typically from about 0.05 to 0.25 inch, and often from about 0.05 to 0.15 inch. In an embodiment, plate 340 may be of a size suitable for being disposed substantially horizontally within separation vessel 310, such that any peripheral gap or distance between the perimeter of plate 340 and the perimeter of separation vessel 310 is in the range from about 0 to 0.20 inch, and typically from about 0 to 0.10 inch.

FIG. 8B is a plan view of separator plate 340, according to the present invention. Separator plate 340 may include a plurality of slots 344. In an embodiment, each slot 344 may be elongate or oblong. The plurality of slots 344 may be arranged substantially parallel to each other in one or more arrays or rows 342. In an embodiment, the longitudinal axis of each elongate slot 344 may be disposed substantially orthogonal to the longitudinal axis of plate 340. Separator plate 340 may be configured for retaining particles having a diameter equal to or greater than about 0.06 inch.

The number of slots 344 within plate 340 may be generally in the range from about 50 to 1000 per square yard of plate 340, often from about 100 to 750 per square yard, and in some embodiments from about 150 to 500 per square yard of plate 340. In an embodiment, plate 340 may be configured for draining liquid from catalyst slurry 102 at a rate of at least about 200 liters per square yard of separator plate 340 per minute.

FIG. 8C is an enlarged view of a slot 344 of plate 340. Slots 344 may typically have a slot length, S_{L} generally in the range from about 1 to 48 inches, typically from about 2 to 24 inches, and often from about 3 to 12 inches. The slot width, S_{W} may generally be in the range from about 0.025 to 0.8 inches, typically from about 0.05 to 0.5 inches, and often from about 0.05 to 0.25 inches. Slots 344 may typically have a length to width ratio, S_{L}:S_{W} in the range from about 25:1 to 2:1, usually from about 15:1 to 3:1, and often from about 10:1 to 4:1.

FIG. 9A is a plan view of a support unit 350, according to an embodiment of the present invention. Support unit 350 may include first and second lateral support members 352a, 352b, an axial support member 354, and a plurality of transverse support members 356. In an embodiment, each of first and second lateral support members 352a, 352b, axial support member 354, and transverse support members 356 may comprise a metal bar or beam. In a sub-embodiment, each of first and second lateral support members 352a, 352b and axial support member 354 may comprise a C-channel beam. In an embodiment, transverse support members 356 may each comprise a C-channel beam or an angle bar.

Support unit 350 may comprise a metal such as a stainless steel or an alloy, wherein the metal may be corrosion resistant. Typically, the metal will have a melting point at least substantially above about 400° F. As noted hereinabove, support unit 350 may be used alone or in conjunction with a perimeter support member 352′ (see, e.g., FIG. 7B) to support plate 340 within separation vessel 310.

FIG. 9B shows first lateral support member 352a as seen along the lines 9B-9B of FIG. 9A. One or more ends of lateral support member 352a may be beveled. Lateral support member 352a may be configured for being disposed against, or resting on, base 326a of separation vessel 310. Second lateral support member 352b (FIG. 9A) may have essentially the same features as described for first lateral support member 352a. In an embodiment, one or more of lateral support members 352a, 352b and axial support member 354 may have a plurality of through holes 358 configured to allow the passage of liquid therethrough.

First lateral support member 352a may have a height, M_{H} in the range from about 2 to 24 inches, typically from about 3 to 12 inches, and often from about 4 to 9 inches. First lateral support member 352a may have a length, M_{L} generally in the range from about 10 to 40 feet, more typically from about 15 to 30 feet, and often from about 20 to 25 feet. In an embodiment, axial support member 354 may have a length substantially the same as that of lateral support members 352a, 352b.

In an embodiment, support unit 350 may be inserted in separation vessel 310, and thereafter plate 340 may be disposed on support unit 350. In another embodiment, plate 340 may be affixed to support unit 350 prior to insertion of plate 340 and support unit 350 into separation vessel 310. In another embodiment, separation vessel 310 may include a perimeter support member 352′ (see, e.g., FIG. 7B), and perimeter support member 352′ may be affixed to separation vessel 310. It is to understood that the invention is not limited to particular types of support units 350.

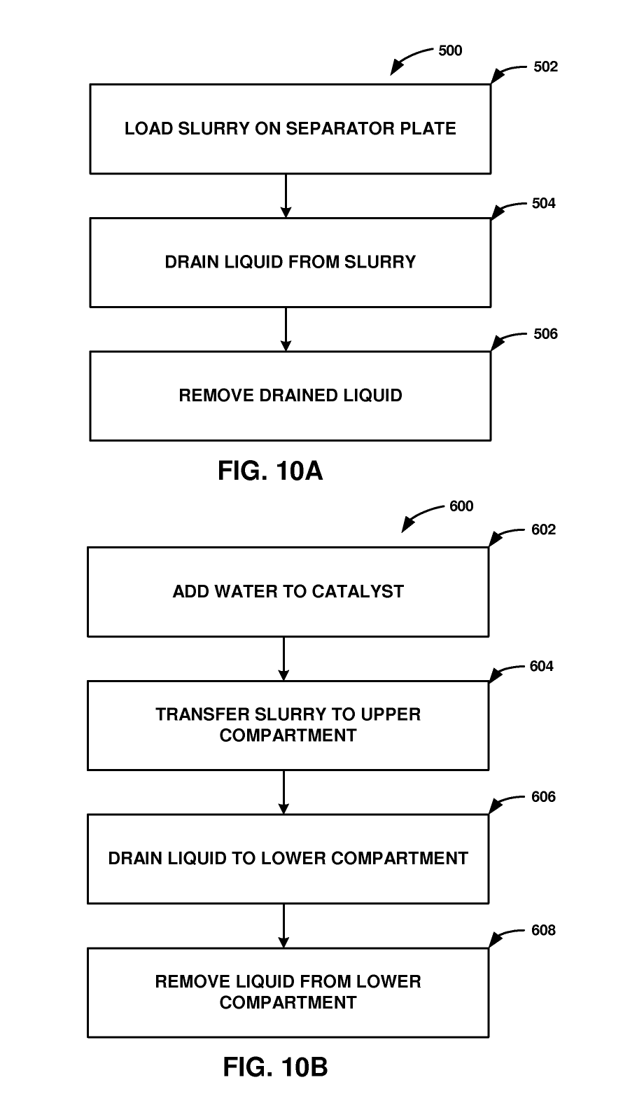

FIG. 10A schematically represents a series of steps involved in a method 500 for handling spent catalyst, according to an embodiment of the present invention. As non-limiting examples, the catalyst may comprise a refractory oxide and/or a molecular sieve, such as a zeolite. Step 502 may involve loading catalyst slurry on a separator plate. The catalyst slurry may be an aqueous slurry comprising spent catalyst from a reactor. The catalyst slurry may be formed by adding water to the spent catalyst in the reactor, e.g., at a water pressure in the range from about 1 bar to about 20 bar. The catalyst slurry may be loaded on the separator plate by transferring the catalyst slurry via gravity feed from the reactor to a location above the separator plate.

The separator plate may be at least substantially planar, and may be disposed at least substantially horizontally within a separation vessel. The catalyst slurry may be fed to an upper compartment of the separation vessel above the separator plate. The plate may include a plurality of slots therein. The separation vessel and separator plate may each have other elements, features and characteristics substantially as described hereinabove, e.g., with reference to FIGS. 3, 4, 5A-B, 6A-B, 7A-B, and 8A-C.

The separator plate may be disposed within the separation vessel such that the plate is at least substantially parallel to the base of the separation vessel. The walls of the separation vessel may be at least substantially orthogonal to the base of the vessel. In an embodiment, the catalyst slurry may be transferred to the separator plate via an open top of the separation vessel.

Step 504 may involve draining liquid from the catalyst slurry through the slots in the separator plate, whereby the liquid is drained from the slurry to a lower compartment beneath the plate. The liquid may be drained from the slurry to the lower compartment at ambient pressure under gravity. In an embodiment, the liquid may be drained from the slurry during step 504 at a rate of at least about 200 liters of liquid per square yard of the plate per minute, typically at least about 500 liters of the liquid per square yard of the plate per minute, and in some embodiments at least about 750 liters of the liquid per square yard of the plate per minute. In an embodiment, the catalyst slurry loaded on the plate may automatically and instantaneously begin to drain, under gravity, through the slots in the plate. Accordingly, step 504 may be performed concurrently with step 502.

Step 506 may involve removing the liquid from the lower compartment. The liquid may be removed from the lower compartment by any suitable method, such methods being well known to the skilled artisan. In an embodiment, the liquid may be removed via an outlet valve mounted on a wall of the lower compartment. Step 506 may be performed concurrently with steps 502 and 504. By removing liquid (step 506) concurrently with the step of draining the liquid from the slurry (step 504), a lower compartment having a relatively small volume may be used for practicing the instant invention. Accordingly, for a separation vessel of a given size, a relatively larger upper compartment may be provided for receiving the catalyst slurry and for containment of drained catalyst. Although the separation vessel may be equipped with a lid, the lid may be at least partially open during steps 502 through 506, and the equipment of the present invention may be operated as an open system.

FIG. 10B schematically represents a series of steps involved in a method 600 for handling spent catalyst, according to another embodiment of the present invention. Step 602 may involve adding water to the catalyst to form an aqueous catalyst slurry. In an embodiment, the water may be added to the catalyst in the reactor after the reactor has been shut down and the catalyst has cooled to a temperature typically not greater than about 212° F. As a non-limiting example, the water may be added to the catalyst in the reactor at a water pressure in the range of about 1 bar to about 20 bar, and typically from about 10 bar to 15 bar. The use of water at a pressure substantially above about 10 bar may accelerate the addition of water to the catalyst, such that step 602 may be completed more quickly.

Step 604 may involve transferring the catalyst slurry to an upper compartment of a separation vessel, the separation vessel having a substantially planar separator plate disposed therein. The slurry may be transferred from the reactor to the upper compartment of the separation vessel via gravity feed. The separator plate may be disposed at least substantially parallel to the base of the separation vessel. The base of the separation vessel may be at least substantially rectangular. The plate may define a boundary between the upper compartment and a lower compartment of the separation vessel. The plate may have a plurality of slots therein for the drainage of liquid therethrough.

In an embodiment, the catalyst slurry may be fed to the separation vessel via a slurry distribution unit configured for evenly distributing the slurry to the plate. The distribution unit may include a distribution nozzle. In an embodiment, the distribution nozzle may be configured to swivel or pivot during step 604, such that the orientation of the nozzle with respect to the separation vessel may be varied.

Step 606 may involve draining liquid, under gravity, from the catalyst slurry through the slots in the separator plate to the lower compartment. In an embodiment, step 606 may involve draining the liquid at ambient pressure under gravity, substantially as described with reference to step 504, method 500, supra.

Step 608 may involve removing the liquid from the lower compartment, wherein step 608 may be performed concurrently with step 606. Step 608 may be performed substantially as described with reference to step 506, method 500, supra.

Numerous variations of the present invention may be possible in light of the teachings and examples herein. It is therefore understood that within the scope of the following claims, the invention may be practiced otherwise than as specifically described or exemplified herein.

What is claimed is:

1. A method for handling spent catalyst, comprising:
a) loading an aqueous catalyst slurry on a rigid separator plate having a plurality of slots therein, wherein the separator plate is disposed at least substantially horizontally;
b) draining liquid from the catalyst slurry through the slots to a lower compartment beneath the separator plate; and
c) removing the liquid from the lower compartment.

2. The method according to claim 1, wherein:
the separator plate is at least substantially planar, and
the separator plate is disposed within a separation vessel at least substantially parallel to the base of the separation vessel.

3. The method according to claim 1, wherein step a) comprises transferring the catalyst slurry via gravity feed from a reactor to a location above the separator plate.

4. The method according to claim 1, wherein:
the separator plate is disposed within a separation vessel, and
step a) comprises transferring the catalyst slurry to the separator plate via an open top of the separation vessel.

5. The method according to claim 1, wherein:
the catalyst slurry is formed by adding water to the spent catalyst in a reactor at a water pressure in the range of about 1 bar to about 20 bar, and
step a) comprises removing the catalyst slurry from the base of the reactor by gravity.

6. The method according to claim 1, wherein:
step b) is performed concurrently with step a), and
step b) comprises draining the liquid, at ambient pressure under gravity, at a rate of at least about 200 liters of liquid per square yard of the separator plate per minute.

7. A method for handling spent catalyst, comprising:
a) adding water to the spent catalyst to form an aqueous catalyst slurry;
b) transferring the catalyst slurry via gravity feed to an upper compartment of a separation vessel, the separation vessel having a substantially planar separator plate disposed therein, the separation vessel having a base, the separator plate disposed at least substantially parallel to the base of the separation vessel, the separator plate defining a boundary between the upper compartment and a lower compartment of the separation vessel, and the separator plate having a plurality of slots therein; and
c) via the separator plate, draining liquid under gravity from the catalyst slurry through the slots to the lower compartment.

8. The method according to claim 7, wherein:
step b) comprises transferring the catalyst slurry to the separation vessel via a slurry distribution unit configured for evenly distributing the catalyst slurry to the separator plate,
step c) comprises draining the liquid, at ambient pressure under gravity, at a rate of at least about 200 liters of liquid per square yard of the separator plate per minute, and the method further comprises:
d) concurrently with step c), removing the liquid from the lower compartment.

9. Apparatus comprising:
a separation vessel having an upper compartment and a lower compartment; and
a rigid, substantially planar separator plate disposed at least substantially horizontally within the separation vessel, the separator plate defining a boundary between the upper compartment and the lower compartment, and the separator plate having a plurality of elongate slots therein, wherein the separator plate is disposed within the separation vessel at least substantially parallel to the base of the separation vessel.

10. The apparatus according to claim 9, wherein:
each of the upper compartment and the lower compartment is configured as a substantially rectangular box, and
the upper and lower compartments are vertically aligned.

11. The apparatus according to claim 9, wherein the upper compartment has a height, U_{H}, the lower compartment has a height, L_{H}, and the U_{H}:L_{H} ratio is in the range from about 5:1 to 20:1.

12. The apparatus according to claim 9, further comprising a support unit configured for supporting the separator plate within the separation vessel.

13. The apparatus according to claim 12, wherein:
the support unit comprises a plurality of support members, and
the support unit is configured for resting at least a portion of the support unit on the base of the separation vessel.

14. The apparatus according to claim 12, wherein:
the support unit comprises a perimeter support member, and
the perimeter support member extends inwardly from the perimeter of the separation vessel.

15. The apparatus according to claim 9, wherein:
the separator plate is configured for draining liquid from a slurry, and
the separator plate is further configured for retaining particles having a diameter equal to or greater than about 0.06 inch.

16. The apparatus according to claim 9, wherein:
the separator plate includes a plurality of elongate slots, each slot having a width in the range from about 0.025 to 0.80 inch, and
the slots have a length to width ratio in the range from about 15:1 to 3:1.

17. The apparatus according to claim 9, wherein:
the separator plate comprises a single layer of a stainless steel or alloy, and
the separator plate has a thickness in the range from about 0.025 to 0.5 inch.

18. The apparatus according to claim 9, further comprising a peripheral flap disposed adjacent to the separator plate, wherein the flap extends substantially between the perimeter of the separator plate and the perimeter of the separation vessel.

19. The apparatus according to claim 9, wherein the base of the separation vessel comprises an entire interior surface.

20. The apparatus according to claim 9, wherein:
the separation vessel comprises opposing first and second side walls, and opposing first and second end walls, and
each of the first and second side walls and the first and second end walls is at least substantially orthogonal to the base of the separation vessel.
